(19) United States
(12) Patent Application Publication
(10) Pub. No.: US 2007/0025891 A1
(43) Pub. Date: Feb. 1, 2007

(54) Apparatus for synthesizing carbon nanotubes

(75) Inventors: Chi-Chuang HO, Tu-Cheng (TW); Ching-Chou Chang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/411,550

(22) Filed: Apr. 26, 2006

(30) Foreign Application Priority Data
Jul. 29, 2005 (CN) 2005 10036290.6

(51) Int. Cl. B01J 19/08

(52) U.S. Cl. 422/186.26

(57) ABSTRACT

An apparatus for synthesizing nanotubes is provided. The apparatus includes a reactor, a first electrode and a second electrode, and an actuator. The reactor is configured for receiving a catalyst used for growing nanotubes. The first electrode and the second electrode are disposed in the reactor and configured for generating an electric field therebetween. The second electrode is spaced apart from the first electrode and movable relative to the first electrode along a direction perpendicular to another direction oriented from the first electrode to the second electrode. The actuator is configured for adjusting a direction of the electric field generated by the first electrode and the second electrode.

### BACKGROUND

1. Technical Field

The present invention relates to an apparatus for synthesizing nano-materials, and more particularly to an apparatus for synthesizing nanotubes.

2. Related Art

Carbon nanotubes are very small tube-shaped structures essentially having the composition of a graphite sheet, formed as a tube. Carbon nanotubes produced by arc discharge between graphite rods were first discovered and reported in an article by Sumio Iijima entitled “Helical Microtubules of Graphitic Carbon” (Nature, Vol. 354, Nov. 7, 1991, pp. 56-58).

Carbon nanotubes are electrically conductive along their length, are chemically stable, and can have very small diameters (much less than 100 nanometers) and large aspect ratios (length/diameter). Due to these and other properties, it has been suggested that carbon nanotubes can play an important role in fields such as microscopic electronics, field emission devices, thermal interface materials, etc.

Currently, a chemical vapor deposition method is widely used for making carbon nanotubes. Chemical vapor deposition is relatively simple, inexpensive, easily scalable, and conducive to growing carbon nanotubes with well alignment. For example, a method for synthesizing well aligned carbon nanotubes on a silicon substrate is reported in an article by S. S. Fan et al. entitled “self-oriented regular arrays of carbon nanotubes and their field emission properties” (Science, Vol. 283, pp. 512-514, Jan. 22, 1999); and a method for synthesizing large-scale well aligned carbon nanotubes on a glass substrate reported in an article by Z. F. Ren et al. entitled “synthesis of large arrays of well-aligned carbon nanotubes on glass ” (Science, vol. 282, pp. 1105-1107, Nov. 6, 1998). However, in all the above-mentioned methods, it is difficult to properly control a direction along which the aligned carbon nanotubes extend, and then the aligned carbon nanotubes simply extend perpendicularly from the substrate.

What is needed, therefore, is an apparatus for synthesizing carbon nanotubes, which allows the control of growth direction of the carbon nanotubes, thereby carbon nanotubes extending along various predetermined directions are obtainable.

### SUMMARY

In a preferred embodiment, an apparatus for synthesizing carbon nanotubes is provided. The apparatus includes a reactor, a first electrode and a second electrode, and an actuator. The reactor is configured for receiving a catalyst used for growing carbon nanotubes. The first electrode and the second electrode are disposed in the reactor and configured for generating an electric field therebetween. The second electrode is spaced apart from the first electrode and movable relative to the first electrode along a first direction substantially perpendicular to a second direction oriented from the first electrode to the second electrode. The actuator is configured for adjusting a direction of the electric field generated by the first electrode and the second electrode.

The apparatus for synthesizing carbon nanotubes in accordance with the preferred embodiment can synthesize carbon nanotubes extending along various predetermined directions. This is because that the apparatus can provide electric fields having various predetermined directions; the carbon nanotubes synthesized can respond freely to an electric field-alignment effect originating from a high polarizability of the carbon nanotubes, and then extend along the electric fields.

Other advantages and novel features will become more apparent from the following detailed description of embodiments when taken in conjunction with the accompanying drawings.

### BRIEF DESCRIPTION OF THE DRAWINGS

The components in the drawings are not necessarily to scale, the emphasis instead being placed upon clearly illustrating the principles of the present apparatus for synthesizing carbon nanotubes. Moreover, in the drawings, like reference numerals designate corresponding parts throughout the several views.

FIG. 1 is a schematic, cross-sectional view of an apparatus for synthesizing carbon nanotubes in accordance with a preferred embodiment.

FIG. 2 is a schematic, cross-sectional view illustrating a plurality of carbon nanotubes formed on a catalyst received in the apparatus of FIG. 1, the carbon nanotubes extending along a predetermined direction aligned with the electric field.

FIG. 3 is a schematic, cross-sectional view illustrating a plurality of carbon nanotubes formed on a catalyst received in the apparatus of FIG. 1, the carbon nanotubes extending from another predetermined direction aligned with the electric field.

The exemplifications set out herein illustrate at least one preferred embodiment, in one form, and such exemplifications are not to be construed as limiting the scope of the apparatus in any manner.

### DETAILED DESCRIPTION OF THE EMBODIMENTS

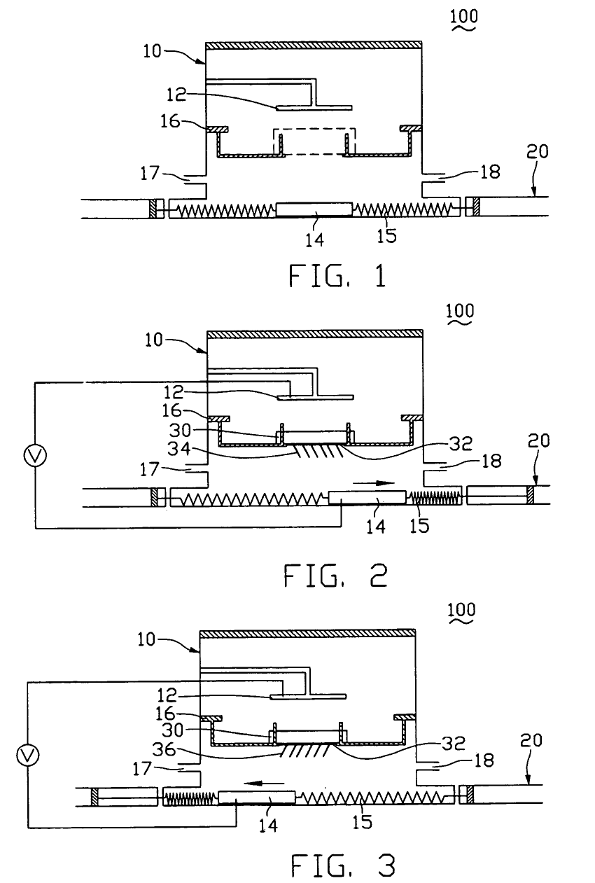

Referring to FIG. 1, an apparatus 100 for synthesizing carbon nanotubes in accordance with a preferred embodiment is provided. The apparatus 100 includes a reactor 10, a first electrode 12 and a second electrode 14, and an actuator 20.

The reactor 10 is configured for receiving a catalyst used for growing carbon nanotubes. The reactor 10 may be a chemical vapor deposition (commonly known as CVD) reactor with a reactor chamber. The reactor 10 includes a gas inlet 17 and a gas outlet 18 opposite to the gas inlet 17. Generally, the gas inlet 17 is used for introducing a reactant gas containing carbon source gas (e.g., methane, ethylene, acetylene, etc.) into the reaction chamber of the reactor 10, and that the gas outlet 18 is used for discharging an exhaust gas for the reactor chamber of the reactor 10. Preferably, the gas inlet 18 and the gas outlet 18 are located at opposite sidewalls of the reactor chamber of the reactor 10. It is understood that the reactor 10 may be any other suitable apparatus well known in the art.

The first electrode 12 and the second electrode 14 are configured for generating an electric field therebetween. The first electrode 12 and the second electrode 14 are disposed in the reactor chamber of the reactor 10 and spaced apart from each other. A space is defined between the first electrode 12 and the second electrode 14 and configured for receiving the catalyst received in the reactor 10. The second electrode 14 is movable relative to the first electrode 12. The first electrode 12 and the second electrode 14 are electrically connected to a power source via an external circuit (not shown) in order to generate an electric field therebetween. When the relative position of the second electrode 14 with respect to the first electrode 12 is varied, a direction of an electric field generated between the first electrode 12 and the second electrode 14 can be changed. In the illustrated embodiment, the first electrode 12 is fixed while the second electrode 14 is movable. The first electrode 12 and the second electrode 14 are usually in the form of metal plates. It is understood that both the first electrode 12 and the second electrode 14 are movable instead.

Preferably, a holder 16 configured for holding the catalyst received in the reactor 10 between the first electrode 12 and the second electrode 14 is provided. In the illustrated embodiment, the holder 16 includes a plurality of cantilevers, for example, two cantilevers. The cantilevers are installed on opposite sidewalls of the reactor chamber of the reactor 10. The cantilevers are spaced apart from each other and define a region therebetween (as denoted by the dash line rectangle in FIG. 1). The region is located between the first electrode 12 and the second electrode 14 and configured for receiving the catalyst used for growing carbon nanotubes. It is understood that the catalyst received in the reactor 10 can be placed between the first electrode 12 and second electrode 14 by way of directly forming the catalyst on a surface of the first electrode 12 or of the second electrode 14 instead. That is, the holder 16 is not necessarily to be provided in a manner.

The actuator 20 is configured for adjusting a direction of the electric field generated by the first electrode 12 and the second electrode 14. The actuator 20 is usually used to move at least one of the first electrode 12 and the second electrode 14, so as to set the direction of the electric field. The actuator 20 usually includes one or more pneumatic or hydraulic piston cylinder assemblies, or other suitable actuating devices. In the illustrated embodiment, the actuator 20 includes two pneumatic piston cylinder assemblies each having a piston capable of linear reciprocation within a cylinder. The two pistons are connected with opposite ends of the second electrode 14 via flexible members 15, for example, springs.

A principle for synthesizing carbon nanotubes extending along a predetermined direction using the apparatus 100 will be described below in detail with reference to FIGS. 2 and 3.

Referring to FIG. 2, a catalyst 32 for growing carbon nanotubes is received in the reactor chamber of the reactor 10 and held between the first electrode 12 and the second electrode 14 by the holder 16. The catalyst 32 is usually supported by a substrate 30. Suitable substrate materials include a variety of materials, including metals, semiconductors and insulators such as silicon (Si), alumina (Al₂O₃), glass and quartz. It is possible that the substrate 30 will, in practice, be a portion of a device, e.g., a silicon-based integrated circuit device, on which nanotube formation is desired. The second electrode 14 is shifted along a direction (as denoted by the arrow in FIG. 2, being substantially perpendicular to a direction oriented from the first electrode 12 to the second electrode 14) to a predetermined position via the actuator 20.

During a process of growing carbon nanatubes 34 on the catalyst 32 by a chemical vapor deposition method, for example, a thermal chemical vapor deposition method, or a plasma-enhanced chemical vapor deposition method, etc, or after the carbon nanotubes 34 are grown; an appropriate voltage (DC or AC voltage) is applied on the first electrode 12 and the second electrode, whereby a sufficiently strong electric field which has a predetermined direction for directing carbon nanotubes 34 is generated by the first electrode 12 and the second electrode 14.

It has been discovered that the optimum electric field for directed growth of carbon nanotubes 34 is in the range from 0.5 to 2 volts per micron. In the electric field, the carbon nanotubes 34 formed on the catalyst 32 are highly polarized. This is because each carbon nanotube is a tubular nanostructure and has an anisotropic morphology, large dipole moments along the tube axis of nanotube induced by the electric field are much higher than dipole moments induced perpendicular to the tube axis. The large induced dipole moments lead to relatively large aligning torques and forces on the carbon nanotubes 34. Accordingly, an electric field alignment effect originating from the high polarizability of the carbon nanotubes 34 occurs, and then the carbon nanotubes 34 respond freely to the electric field alignment effect and extend along the electric field direction.

Referring to FIG. 3, the second electrode 14 is shifted along another direction (as denoted by the arrow in FIG. 3, being substantially perpendicular to a direction oriented from the first electrode 12 to the second electrode 14) to another predetermined direction via the actuator 20. During a chemical vapor deposition process of growing carbon nanotubes 36 on the catalyst 32, or after the carbon nanotubes 36 are grown; an appropriate voltage is applied on the first electrode 12 and the second electrode 14, whereby a sufficiently strong electric field which has another predetermined direction for directing carbon nanotubes 36 is generated by the first electrode 12 and the second electrode 14. The optimum electric field is in the range from 0.5 to 2 volts per micron. Accordingly, an electric field alignment effect originating from the high polarizability of carbon nanotubes 36 occurs; and then the carbon nanotubes 36 formed on the catalyst 32 respond freely to the electric field-alignment effect and extend along the electric field direction.

As above described, when an appropriate voltage is applied on the first electrode 12 and the second electrode 14, an electric field can be generated by the first electrode 12 and the second electrode 14, whereby an electric field alignment effect originating from the high polarizability of carbon nanotubes 34, 36 occurs. Accordingly, carbon nanotubes 34, 36 formed on the catalyst 32 respond freely to the electric field alignment effect and extend along the electric fields. Additionally, the relative position of the second electrode 14 with respect to the first electrode 12 is adjustable by means of the actuator 20, which can result in electric fields between the first electrode 12 and the second electrode 14 having various predetermined directions. As a result, carbon nanotubes extending along various predetermined directions are obtainable.

It is understood that the apparatus 100 also can be used for synthesizing other tubular nanostructures, such as silicon nanotubes, and boron nanotubes, etc. Base on the principle as above described, the other tubular nanostructures extending along various predetermined directions also are obtainable.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An apparatus for synthesizing carbon nanotubes, the apparatus comprising:
a reactor configured for receiving a catalyst used for growing carbon nanotubes;
a first electrode and a second electrode, the first electrode and the second electrode being disposed in the reactor and configured for generating an electric field therebetween, the second electrode being spaced apart from the first electrode and movable relative to the first electrode along a first direction which is substantially perpendicular to a second direction oriented from the first electrode to the second electrode; and
an actuator configured for adjusting a direction of the electric field generated by the first electrode and the second electrode.

2. The apparatus of claim 1, further comprising a holder configured for holding the catalyst received in the reactor between the first electrode and the second electrode.

3. The apparatus of claim 2, wherein the holder comprises a plurality of cantilevers installed on opposite sidewalls of the reactor and spaced apart from each other.

4. The apparatus of claim 3, wherein the reactor comprises a gas inlet and a gas outlet opposite to the gas inlet, the gas inlet and the gas outlet are located at opposite sidewalls of the reactor.

5. The apparatus of claim 1, wherein the first electrode and the second electrode are in the form of metal plates.

6. The apparatus of claim 1, wherein the actuator comprises one or more piston cylinder assemblies connected with at least one of the first electrode and the second electrode.

7. The apparatus of claim 6, wherein the one or more piston cylinder assemblies are selected from the group consisting of pneumatic piston cylinder assemblies and hydraulic piston cylinder assemblies.

8. An apparatus for synthesizing nanotubes, comprising:
a chemical vapor deposition reactor;
a first electrode and a second electrode, the first electrode and the second electrode being disposed in the reactor and configured for generating an electric field therebetween, the second electrode being movable relative to the first electrode along a first direction which is substantially perpendicular to a second direction oriented from the first electrode to the second electrode, the first electrode and the second electrode being spaced apart from each other and defining a space therebetween for receiving a catalyst used for growing nanotubes; and
an actuator configured for adjusting a direction of the electric field generated by the first electrode and the second electrode.

9. The apparatus of claim 8, further comprising a holder configured for holding the catalyst received in the space between the first electrode and the second electrode.

10. The apparatus of claim 9, wherein the holder comprises a plurality of cantilevers installed on opposite sidewalls of the reactor and spaced apart from each other.

11. The apparatus of claim 10, wherein the reactor comprises a gas inlet and a gas outlet opposite to the gas inlet, the gas inlet and the gas outlet are located at opposite sidewalls of the reactor.

12. The apparatus of claim 8, wherein the first electrode and the second electrode are in the form of metal plates.

13. The apparatus of claim 8, wherein the actuator comprises one or more piston cylinder assemblies connected with at least one of the first electrode and the second electrode.

14. The apparatus of claim 13, wherein the one or more piston cylinder assemblies are selected from the group consisting of pneumatic piston cylinder assemblies and hydraulic piston cylinder assemblies.
